(19) United States
(12) Patent Application Publication
(10) Pub. No.: US 2012/0015721 A1
(43) Pub. Date: Jan. 19, 2012

(54) DISPLAY DEVICE FOR AN ELECTRONIC GAME

(76) Inventors: Kagney S. Colbert-Carr, Murphy, NC (US); Timothy R. Allen, Hillsborough, NC (US)

(21) Appl. No.: 12/835,269

(22) Filed: Jul. 13, 2010

(51) Int. Cl. A63F 13/00; A63F 13/06

(52) U.S. Cl. 463/30; 463/36

(57) ABSTRACT

A game controller, gaming system for multi-player games, and an associated method are provided. The system is configured for situations in which multiple players are in one location. The system includes a secondary display assembly in viewing proximity to a single player and a console operable to output singe player-specific tactical information to the secondary display assembly, receive game input information from a game controller operated by the single player, and output display information other than single player-specific tactical information to a primary display assembly for viewing by each of the players.

### TECHNICAL FIELD

The presently disclosed subject matter is directed towards a display device and system for an electronic game, and more particularly, towards a display device and system for use in multi-player gaming systems.

### BACKGROUND

Gaming systems typically include a gaming console that is operable to output a display signal to a display screen and receive control commands from a gaming controller. The gaming controller is operated by the player to output commands in order to direct the gaming console to manipulate the game by a desired command operation.

Many gaming systems are played by multiple players simultaneously. In some instances, this may be accomplished through an internet connection such that multiple players may be in different locations while playing the game. However, in other instances, each of or more than one players may be located at a single location. In this instance, each of the players is viewing the same display screen simultaneously. For some games, this is undesirable because the gaming console outputs single player-specific tactical information on the display screen that would advantageously be viewable by only a single player. For example, if two players are simultaneously playing a game at the same location, each player may be able to view the other player's tactical information. This is undesirable because this information may provide each player some indication of the other player's next tactical move.

Accordingly, a need exists for a manner to address the problems associated with having multiple players playing a game at one location.

### SUMMARY

According to one aspect of the disclosed subject matter, a secondary display assembly for use with a multi-player gaming system in which multiple players are centrally located and viewing a primary display assembly is provided. The secondary display assembly is configured for receiving single player-specific tactical information from the gaming system and displaying the single player-specific tactical information in viewing proximity to a single player.

According to one aspect of the disclosed subject matter, the secondary display assembly comprises a sleeve having a display panel carried thereon and configured for receiving a player's arm.

According to one aspect of the disclosed subject matter, the display panel of the secondary display assembly is configured for sending player selected control information to the gaming system.

According to one aspect of the disclosed subject matter, the display panel of the secondary display assembly comprises touch-responsive sensors operable to receive touch input from the single player to thereby output player selected control information associated therewith to the gaming system.

According to one aspect of the disclosed subject matter, the secondary display assembly is coupled to the gaming system.

According to one aspect of the disclosed subject matter, the secondary display assembly is wirelessly coupled to the gaming system.

According to one aspect of the disclosed subject matter, a primary display assembly is provided in communication with the gaming system for displaying information other than single player-specific tactical information.

According to one aspect of the disclosed subject matter, the primary display assembly does not display single player-specific tactical information.

According to one aspect of the disclosed subject matter, a game controller is provided and includes touch-responsive sensors operable to receive touch input from the single player and output information associated therewith to the gaming system.

According to one aspect of the disclosed subject matter, A gaming system for multi-player games is provided. The system includes a display assembly in viewing proximity to a single player and a console operable to output singe player-specific tactical information to the display assembly, receive game input information from a game controller operated by the single player, and send display information other than single player-specific tactical information to a primary display assembly for viewing by each of the players.

According to one aspect of the disclosed subject matter, a method of displaying tactical information to a single player in a multi-player gaming system in which multiple players are centrally located about a primary display assembly is provided. The method includes sending single player-specific tactical information data to a secondary display assembly in viewing proximity to the single player.

According to one aspect of the disclosed subject matter, the method includes displaying information other than the single player-specific tactical information on a primary display assembly for viewing by each of the players.

According to one aspect of the disclosed subject matter, the secondary display assembly includes touch-responsive sensors operable to receive touch input from the single player, and further comprising outputting command information associated with a respective touch-responsive sensor to the multi-player gaming system.

### BRIEF DESCRIPTION OF THE DRAWINGS

The foregoing summary, as well as the following detailed description of preferred embodiments, is better understood when read in conjunction with the appended drawings. For the purposes of illustration, there is shown in the drawings exemplary embodiments; however, the presently disclosed subject matter is not limited to the specific methods and instrumentalities disclosed. In the drawings:

FIG. 1 is a perspective view of a multiple players playing a multi-player gaming system;

FIG. 2 is a perspective view of multiple players playing a multi-player gaming system according to an embodiment of the disclosed subject matter; and

FIG. 3 is a flow chart depicting an operation of the gaming system according to an embodiment of the disclosed subject matter.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “circuit,” “module,” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter situation scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flowchart and/or block diagram block or blocks.

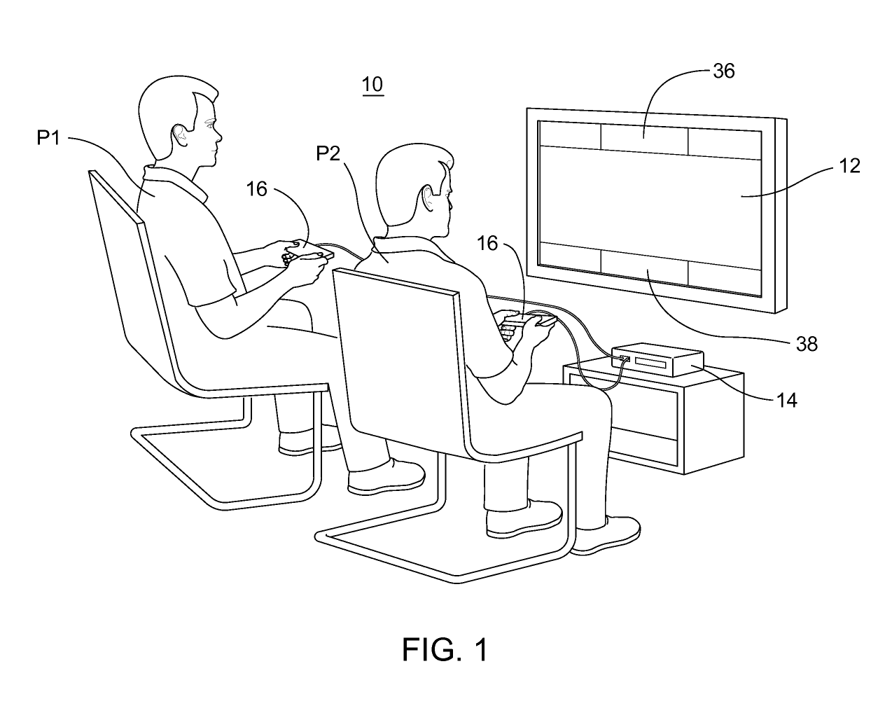

FIG. 1 illustrates a conventional gaming system 10. The gaming system 10 includes a display assembly 12 such as a television that is in communication with a game console 14. The game console 14 is configured to output video display signals to the display assembly 12. A controller 16 is in communication with the game console 14. The controller 16 may have any variety of touch-responsive controls provided thereon. Upon touching of the touch-responsive controls by either player P1 or player P2, the controller 16 outputs command information data to the game console 14 at which time the game console 14 converts the command information data into an appropriate video data response which is then displayed by the display assembly 12.

Some gaming systems are multi-player gaming systems that allow multiple players in one location to play a game against one another. In many of these gaming systems such as system 10 illustrated in FIG. 1, player-specific tactical information is displayed on the display assembly 12. Sometimes this player-specific tactical information is tied to a touch-responsive control on the controller 16 such that the player must view the display assembly 12 while simultaneously selecting a touch-responsive control corresponding to the selection of a desired control information command. As illustrated in FIG. 1, this player-specific tactical information is viewable by all players. For example, FIG. 1 illustrates player-specific tactical information 36 corresponding to the player P1 and player-specific tactical information 38 corresponding to the player P2 on the display assembly 12. In this manner, the tactical information for each respective player is viewable by all of the players. This is undesirable because it may be possible for each player to determine each other player's tactical information selection.

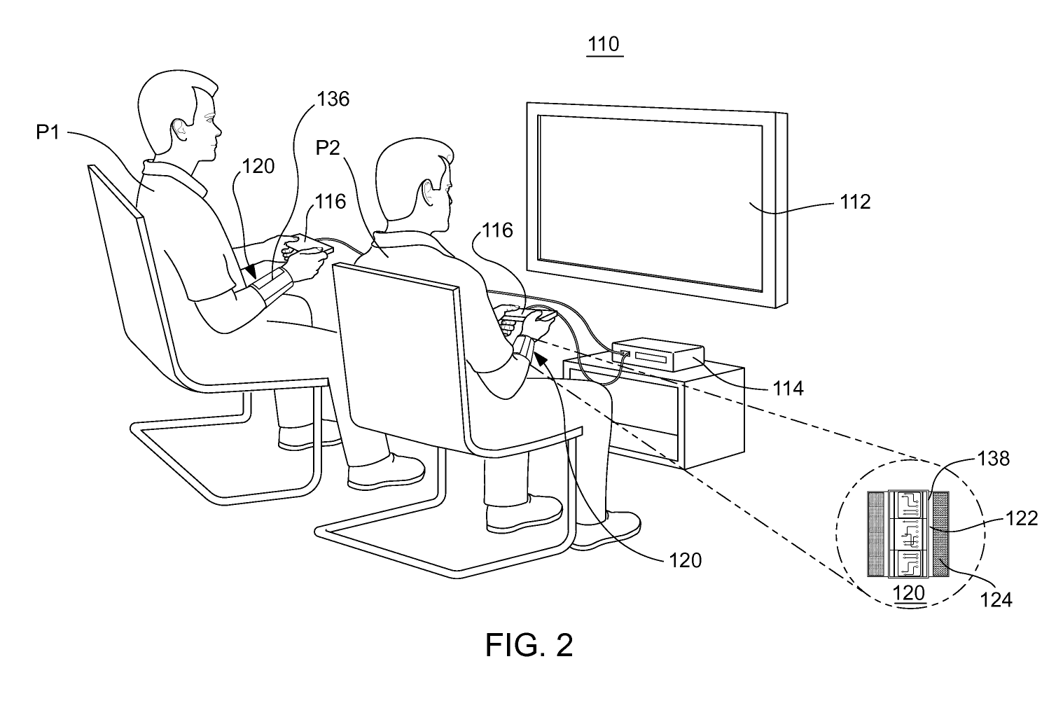

FIG. 2 illustrates a gaming system 110 according to an embodiment of the present invention. The gaming system 110 includes a primary display assembly 112 such as a television that is in communication with a game console 114. The game console 114 is configured to output video display signals to the primary display assembly 112. A controller 116 is in communication with the game console 114. The controller 116 may have any variety of touch-responsive controls provided thereon. Upon touching of the touch-responsive controls, the controller 116 outputs command information data to the game console 114 at which time the game console 114 converts the command information data into an appropriate video data response which is then displayed by the display assembly 112.

The game console 114 is also configured to output tactical information to a secondary display assembly 120. Secondary display assembly 120 is illustrated as a display panel 122 carried by a sleeve 124 that is configured for receiving a player's arm. In this manner, the secondary display assembly 120 is viewable by a single player. Tactical information that may have been displayed on display assembly 112 is instead displayed on the display panel 122 of the secondary display assembly 120. The secondary display assembly 120 may have a plurality of touch-responsive controls positioned thereon such that each respective player may then touch a selected touch-responsive control at which time command information is sent to the game console 114. In another embodiment, the secondary display assembly 120 may not have touch-responsive controls provided thereon and is provided only for viewing additional tactical information, or in other embodiments, the tactical information may have a touch-responsive control associated therewith provided on the controller 16.

As illustrated in FIG. 2, each of players P1 and P2 may have their own secondary display assembly 120. In this embodiment, the secondary display assembly 120 on player P1 may display tactical information 136, which correlates to the tactical information illustrated as 36 in FIG. 1. Additionally, the secondary display assembly 120 on player P2 may display tactical information 138, which correlates to the tactical information illustrated as 138 in FIG. 1. In this manner, the tactical information 36 specific to player P1 as illustrated in FIG. 1 is only viewable on player P1's secondary display assembly 120 by player P1. Likewise, tactical information 38 specific to player 2 P2 as illustrated in FIG. 1 is only viewable on player P2's secondary display assembly 120 by player P2.

Each of the secondary display assemblies 120 may be wireless or hard wire coupled to the game console 114 and may be provided with separate power supplies or may receive power from the game console 114. The secondary display assembly 120 may have a touch-screen, be button operated, switch operated, or the likes for selecting desired command information. While shown as a display panel 122 on a sleeve 124 configured for receiving a player's arm, the disclosed subject matter is not limited to this structural arrangement, and may, in appropriate embodiments, take on many forms including, but not limited to, a separate stand-alone display panel or a panel carried by a game controller. Additionally, each secondary display assembly 120 may be described as single player-specific or being viewed by only a single player, however, in appropriate embodiments, multiple people may be representing a single player as defined by the gaming system such that multiple players could be associated with a single player-specific event.

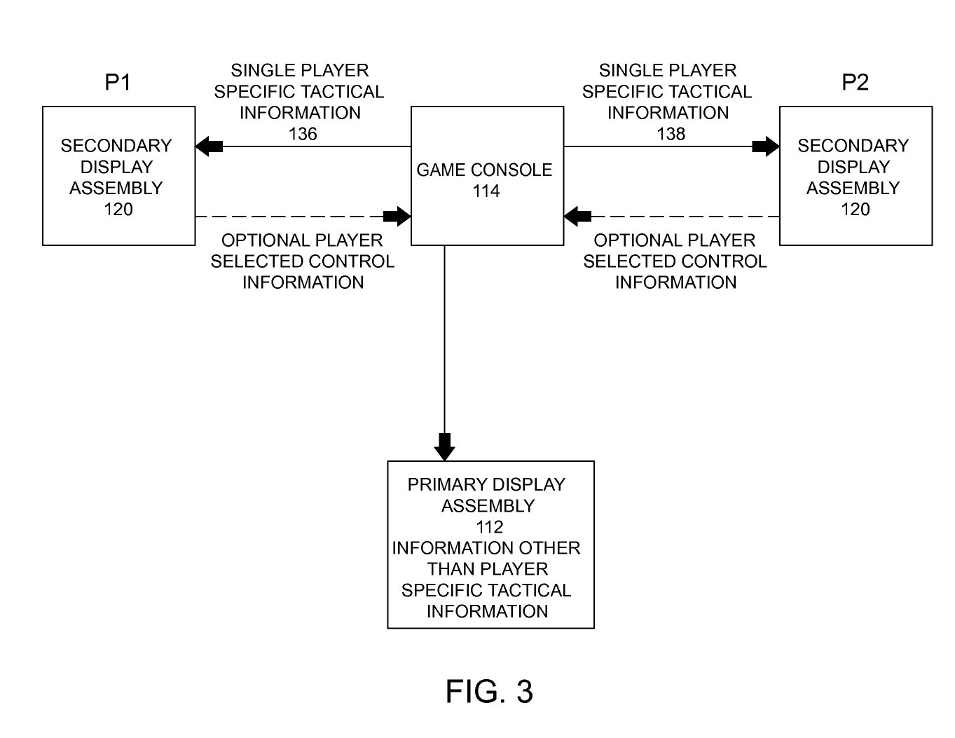

A flow chart of the disclosed subject matter is illustrated in FIG. 3. As shown in FIG. 3, the game console 114 communicates player-specific tactical information 136, 138 to each secondary display assembly 120 of each respective player P1 and P2. Each secondary display assembly 120 will then display player-specific tactical information 136 and 138 to players P1 and P2, respectively. In one or more embodiments, each player P1 and P2 may then optionally transmit player selected control information back to the game console 114 by selecting a touch-responsive sensor on the display assembly 120. The game console then communicates with the primary display assembly 112 to display information other than player-specific tactical information.

While the embodiments have been described in connection with the preferred embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed:

1. A secondary display assembly for use with a multi-player gaming system in which multiple players are centrally located and viewing a primary display assembly, the secondary display assembly configured for receiving single player-specific tactical information from the gaming system and displaying the single player-specific tactical information in viewing proximity to a single player.

2. The secondary display assembly according to claim 1, wherein the secondary display assembly comprises a sleeve having a display panel carried thereon and configured for receiving a player's arm.

3. The secondary display assembly according to claim 2, wherein the display panel of the secondary display assembly is configured for sending player selected control information to the gaming system.

4. The secondary display assembly according to claim 3, wherein the display panel of the secondary display assembly comprises touch-responsive sensors operable to receive touch input from the single player to thereby output player selected control information associated therewith to the gaming system.

5. The secondary display assembly according to claim 1, wherein the secondary display assembly is coupled to the gaming system.

6. The secondary display assembly according to claim 5, wherein the secondary display assembly is wirelessly coupled to the gaming system.

7. The secondary display assembly according to claim 1, further including a primary display assembly in communication with the gaming system for displaying information other than single player-specific tactical information.

8. The secondary display assembly according to claim 7, wherein the primary display assembly does not display single player-specific tactical information.

9. The secondary display assembly according to claim 1, further including a game controller comprising touch-responsive sensors operable to receive touch input from the single player and output information associated therewith to the gaming system.

10. A gaming system for multi-player games, the system comprising:
a display assembly in viewing proximity to a single player; and
a console operable to output singe player-specific tactical information to the display assembly, receive game input information from a game controller operated by the single player, and send display information other than single player-specific tactical information to a primary display assembly for viewing by each of the players.

11. The gaming system according to claim 10, wherein the secondary display assembly comprises a sleeve having a display panel carried thereon and is configured for receiving a player's arm.

12. The gaming system according to claim 11, wherein the secondary display assembly is configured for sending player selected control information to the gaming system.

13. The gaming system according to claim 12, wherein the secondary display assembly comprises touch-responsive sensors operable to receive touch input from the single player to thereby output information associated therewith to the gaming system.

14. The gaming system according to claim 10, wherein the secondary display assembly is coupled to the gaming system.

15. The gaming system according to claim 14, wherein the secondary display assembly is wirelessly coupled to the gaming system.

16. The gaming system according to claim 10, further including a game controller comprising touch-responsive sensors operable to receive touch input from a player and output player selected control information associated therewith to the gaming system.

17. A method of displaying tactical information to a single player in a multi-player gaming system in which multiple players are centrally located about a primary display assembly, comprising sending single player-specific tactical information data to a secondary display assembly in viewing proximity to the single player.

18. The method according to claim 17, further comprising displaying information other than the single player-specific tactical information on a primary display assembly for viewing by each of the players.

19. The method according to claim 17, wherein the secondary display assembly comprises touch-responsive sensors operable to receive touch input from the single player, and further comprising outputting command information associated with a respective touch-responsive sensor to the multi-player gaming system.
